(19) United States
(12) Patent Application Publication
(10) Pub. No.: US 2026/0122296 A1
(43) Pub. Date: Apr. 30, 2026

(54) VIDEO MANAGEMENT SYSTEM LOAD BALANCING

(71) Applicant: Honeywell International Inc., Charlotte, NC (US)

(72) Inventors: Amelia Masters, Wollstonecraft (AU); Alexander Afanasjev, Bellevue Hill (AU)

(21) Appl. No.: 18/927,598

(22) Filed: Oct. 25, 2024

(51) Int. Cl. H04N 21/24; H04N 21/2187

(52) U.S. Cl. CPC H04N 21/24; H04N 21/2187

(57) ABSTRACT

Methods and systems for video management. A system including a plurality of cameras and a plurality of video servers is configured with an allocation of the cameras to the video servers. The system is managed by monitoring load that the cameras place on the video servers to identify imbalances. When imbalance is recognized, the system performs reallocation of the cameras to the video servers.

### BACKGROUND

Video management systems typically include of a plurality of video servers (computers) running software to manage network-connected camera devices. These activities may include (but are not limited to) streaming live video from the camera to client applications, recording video sourced from the camera, and performing video analytics on camera streams. To ensure determinism of processing, each camera is typically assigned to a specific video server. That way one video server can request a video stream from a camera and use it to serve live video, save recorded video, and process analytics, as spreading these tasks across multiple servers would create additional network load in the system if the same camera video needed to be sent to multiple video servers for different purposes.

The assignment of cameras to a specific server can present various difficulties. Some cameras require more processing resources than others. Some cameras have variable processing demands over time. If video servers are incorrectly sized for the camera load they are managing, this can result in server failures and the invocation of failovers to backup video servers. However, if backup servers have the same hardware specifications as the primary video servers (which is typical), the same load taken over with the backup server will simply lead to another failure, and a cascade of failures can result. Further, if the backup server is run idle (a “hot spare”), there is a cost in terms of energy spent to keep the backup server running. Additional problems and details are further discussed below.

What is needed are new and/or alternative solutions for load distribution in video management systems.

### Overview

The present inventors have recognized, among other things, that a problem to be solved is the need for new and/or alternative load management methods, and systems designed for such methods, in handling multiple video feeds such as in a security or building management system.

A first illustrative and non-limiting example takes the form of a method of load management in a video management system, the system including a plurality of cameras and a plurality of video servers, the method comprising: operating the cameras and the video servers with a first allocation of the plurality of cameras to respective video servers; monitoring utilization metrics for each camera at the respective video server for each camera; determining that a first video server is imbalanced relative to at least one other video server; in response to determining the first video server is imbalanced: determining a reallocation of the plurality of cameras to the plurality of video servers, resulting in a second allocation; and implementing the second allocation.

Additionally or alternatively, the step of determining a reallocation of the plurality of cameras to the plurality of video servers comprises: analyzing a state of each of the plurality of cameras to determine whether any of the plurality of cameras cannot be currently re-allocated and, if so, designating such cameras as not floatable; and determining the reallocation without allowing reallocation of any not floatable cameras.

Additionally or alternatively, the step of determining a reallocation of the plurality of cameras to the plurality of video servers comprises: analyzing a state of each of the plurality of cameras to determine whether any of the plurality of cameras cannot be currently re-allocated and, if so, designating such cameras as not floatable and designating the remaining cameras as floatable cameras; and determining the reallocation by allowing reallocation of all of the plurality of cameras; wherein the step of implementing the second allocation comprises reallocating at least one floatable camera at a first time, and reallocating at least one non-floatable camera at a second, later time.

Additionally or alternatively, the step of determining that the first video server is imbalanced comprises comparing, at a video server controller, at least one of CPU utilization, video server memory, video server disk queue, or network utilization of the first video server to that of a second video server.

Additionally or alternatively, the step of determining that the first video server is imbalanced comprises comparing, at a video server controller, at least one of CPU utilization, video server memory, video server disk queue, or network utilization of the first video server to that of an average of the plurality of video servers.

Additionally or alternatively, the method also includes determining that a second video server has failed and can no longer process data from at least a second camera allocated thereto under the first allocation, and in response, reallocating the second camera to another video server.

Additionally or alternatively, the method also includes determining that a second video server has failed and can no longer process data from at least a second camera allocated thereto under the first allocation, and in response, determining a reallocation of the plurality of cameras to the plurality of video servers, less the second video server.

Additionally or alternatively, the method also includes determining that a second video server has been compromised and has a reduced operational capacity in at least one of CPU capability, video server memory, video server disk queue, or network capacity, and in response, determining a reallocation of the plurality of cameras to the plurality of video servers, by updating an estimated capacity of the second video server.

Additionally or alternatively, the method also includes determining that a second video server is overloaded in at least one of CPU utilization, video server memory, video server disk queue, or network utilization, and in response, determining a reallocation of the plurality of cameras to the plurality of video servers, less the second video server.

Additionally or alternatively, the method also includes determining that the first video server is not overloaded by comparison of performance or utilization metrics of the first video server to one or more thresholds for overloading prior to determining that the first video server is imbalanced.

Additionally or alternatively, the video system controller is configured to determine the reallocation of the plurality of cameras to the plurality of video servers using estimates of peak resource utilization demands of the cameras on the video servers without identifying overload of any of the plurality of video servers.

Additionally or alternatively, the method also includes the video system controller is configured to determine the first video server is imbalanced by analysis of time or CPU cycles required for the first video server to accomplish one or more tasks.

Another illustrative and non-limiting example takes the form of a method of load management in a video management system, the system including a plurality of cameras and a plurality of video servers, the method comprising: operating the cameras and the video servers with a first allocation of one or more cameras to respective video servers; monitoring utilization metrics for each camera at the respective video server for each camera; determining that a first video server is imbalanced relative to at least one other video server; and, in response, reallocating a first camera allocated to the first video server in the first allocation to a different video server.

Another illustrative and non-limiting example takes the form of a video management system comprising: a plurality of cameras; a plurality of video servers; a network connecting the plurality of cameras to the plurality of video servers, the network implementing a first allocation of the plurality of cameras to respective video servers; each respective video server in the system configured to monitor utilization metrics for each camera at the respective video server for each camera; and a video system controller configured to: determine that a first video server is imbalanced relative to at least one other video server; and in response to the first video server being imbalanced: determine a reallocation of the plurality of cameras to the plurality of video servers, resulting in a second allocation; and implement the second allocation.

Additionally or alternatively, the video system controller is configured to determine a reallocation of the plurality of cameras to the plurality of video servers by: analyzing a state of each of the plurality of cameras to determine whether any of the plurality of cameras cannot be currently re-allocated and, if so, designating such cameras as not floatable; and determining the reallocation without allowing reallocation of any not floatable cameras.

Additionally or alternatively, the video system controller is configured to determine a reallocation of the plurality of cameras to the plurality of video servers by: analyzing a state of each of the plurality of cameras to determine whether any of the plurality of cameras cannot be currently re-allocated and, if so, designating such cameras as not floatable and designating the remaining cameras as floatable cameras; and determining the reallocation by allowing reallocation of all of the plurality of cameras; further wherein video system controller is configured to implement the second allocation by: reallocating at least one floatable camera at a first time; reallocating at least one non-floatable camera at a second, later time after determining that the non-floatable camera has become floatable due to expiration or ending of a process or condition involving the non-floatable camera.

Additionally or alternatively, the video system controller is configured to determine that the first video server is imbalanced by comparing at least one of CPU utilization, video server memory, video server disk queue, or network utilization of the first video server to that of a second video server.

Additionally or alternatively, the video system controller is configured to determine that the first video server is imbalanced by comparing at least one of CPU utilization, video server memory, video server disk queue, or network utilization of the first video server to that of an average of the plurality of video servers.

Additionally or alternatively, the plurality of video servers are each configured to identify at least one of failure, overload, or compromise, and to communicate such failure, overload, or compromise to the video system controller, and the video system controller is configured, in response thereto, to determine a new allocation of the plurality of cameras to accommodate the communicated failure, overload, or compromise.

Additionally or alternatively, the video system controller is configured to determine that the first video server is imbalanced without the first video server determining a state of overload.

This overview is intended to introduce the subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an illustrative video management system and associated network and cameras;

FIG. 2 schematically illustrates load management;

FIGS. 3A-3B are block flow diagrams for a load management process;

FIG. 4 is a block flow diagram for identifying and responding to video server failure;

FIG. 5 is a block flow diagram for identifying and responding to video server compromise;

FIG. 6 is a block flow diagram for identifying and responding to video server overload; and

FIG. 7 is a block flow diagram for identifying and responding to video server imbalance.

### DETAILED DESCRIPTION

The present disclosure relates generally to video systems, such as video surveillance systems. A video management system may include a plurality of cameras each generating video feeds, either directly to the system or indirectly through a video streamer (in the event a camera is a legacy analog camera, for example). The system may also comprise a plurality of video servers. The quantity of cameras and video servers may vary widely, and may scale up to hundreds or thousands of each.

Processes and systems configured for load management in a video management system are proposed. Some prior art systems are configured to identify and respond to video server failure by pushing all the camera feeds allocated to the failing video server to other video servers by simply identifying the next available video server. Others may hold a video server in reserve as a backup, and when an active video server fails, all the cameras from the failing video server are routed to the backup video server.

Identifying system imbalance, as opposed to outright failure or overload, and responding by balancing a system is not present in these prior systems. The combination identifying imbalance and responding thereto can have the positive impacts of extending server lifetime, improving stability, and/or preventing overload and/or failure type events, is not present in such systems. Furthermore, in some examples, the use of server analytics, related to the capacity of each server, and camera analytics, related to the demands a camera places on a video server, in balancing and rebalancing server/camera allocations may enhance the state of the art by referring to a more granular understanding of several categories of server technical demand that each camera generates. The approaches to balancing, and to identifying and correcting imbalance, are contemplated as possible separate innovations that can be combined together in some examples, though integration of both is not required.

In some examples, extra video server capacity is allocated in a balanced manner, which is different from some prior art approaches. For example, it is known to keep a “hot spare” video server available, in which the video server is unused, but kept active, wasting energy as it remains online even when not used. With a “hot spare”, the active servers in the system handle all the video camera load/traffic, while the backup server is online, but unused. This approach accelerates wear on the active servers. Instead, a balanced approach taken herein may use all the video servers, in some examples, though at lower utilization for those that are active than would be the case if a spare video server were maintained in an on-line, but unused state.

In an example, at an initialization stage, each of the cameras is assigned to one of the video servers. At this point, if prior utilization data is known, it may be used in assigning the cameras. Otherwise, camera demands on the video servers may be estimated based on, for example, characteristics of each camera and/or the area to be monitored for each camera. Such estimation may include modelling camera performance and/or obtaining a camera model.

Different cameras and different installation locations may affect each camera's demands on the video servers. For example, a high-resolution security camera that is used for facial recognition in a high traffic area can be estimated to require more central processing unit (CPU) load, network bandwidth, and/or other resources from a video server than a lower resolution security camera located in a low traffic area. Some security cameras are set with longer or shorter storage loops, in which a portion of the video feed is temporarily stored by the video server in a first-in, first-out loop, consuming video server memory.

As video data streams are generated at each camera, the video servers perform various steps, including analyzing the stream data, preparing stream data for database storage, and generating notifications based on the analyzed data. A system controller, which may be a separate, dedicated computer/server, or may reside on an enterprise server, or may simply be one of the video servers, for example and without limitation, obtains utilization data from each video server for each of the cameras (on a camera-by-camera basis, this may be referred to as camera analytics).

Camera analytics may include, for example and without limitation, one or more of CPU use, video server input/output load and/or network usage (related to the amount of data into and out of the video server), video server disk queue usage, and video server memory usage. For example, network use may refer to the degree of available bandwidth incoming to the video server (or outgoing therefrom) that the video server has to use to keep up with the data from a given one of the cameras. Network utilization may vary for each camera depending on camera resolution and frame rate as well as the number and nature of notifications that are generated based on the data from a given camera. Likewise, CPU use can vary depending on contents of the video feed, for example, a camera that captures generally unchanging images, such as monitoring a low-use hallway, may require less CPU data than a camera which monitors a location having larger amounts of foot traffic. Video server memory usage refers to the amount of pre-record (video held in a memory buffer) for each camera, which can affect available memory on the server. Video server disk queue usage refers to the rate and size of video recording, which can affect the disk write queues for storage attached to the server

In examples, the system control seeks to balance the load on each of the video servers by use of server analytics. For example, server analytics may include network data and CPU data. The system control operates by identifying video servers having relatively higher utilization than other video servers. When imbalance is identified, rebalancing takes place. The rebalancing may consider several factors related to server capability demands by each camera, and may also consider user preferences.

For example, an illustrative system control can respond to one of several events. If one of the video servers fails entirely, the system control will reallocate the video feeds from the cameras to the remaining video servers, and will do so in a manner that provides balanced utilization across the remaining video servers. A relatively simple approach would be to simply allocate an equal number of cameras to each video server. A more sophisticated, and potentially stable approach, is to provide balanced distribution of the camera load across the remaining video servers. “Balanced” distribution may consider, in addition to the camera load, the available capacity of the video serves, as the system may include video servers of varying types, connections, and/or capabilities.

In another example, if a video server becomes compromised, and thus has reduced capacity to handle video feeds from the cameras, the system control may identify, from the cameras linked to the compromised video server, which cameras can be floated to another video server, and then will reallocate cameras that can be floated in a way that balances the camera processing load to other video servers. Finally, if a video server is being overused in comparison to the other video servers, the system control again identifies which cameras are able to be floated to other video servers, and then re-assigns the cameras that can be floated in a way that rebalances the set of video servers. In these re-allocation steps, a camera may not be able to be floated at a given point in time for any of several reasons including, for example, ongoing processes or emergency.

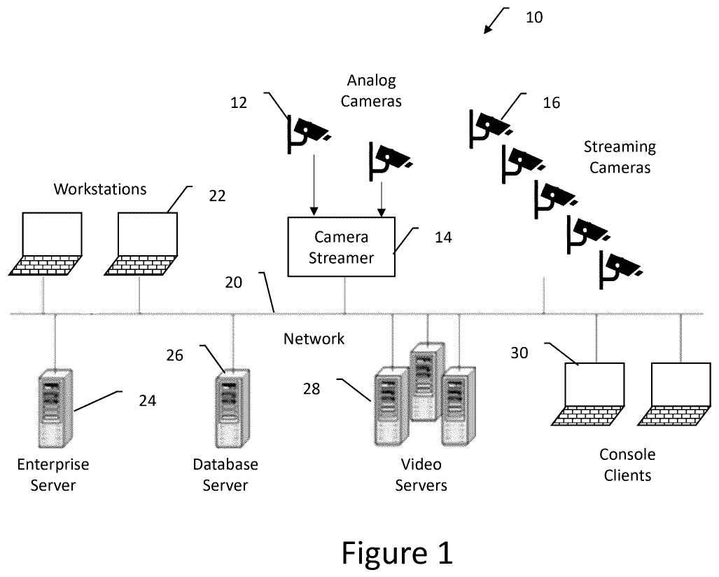

FIG. 1 shows an illustrative video management system and associated network and cameras. The system includes various cameras, such as analog cameras 12, which are connected to a network 20 via a camera streamer 14, as well as digital cameras 16. The present disclosure is not limited to any particular camera type or quantity. The cameras 12/16 may be configured for any desired use. Some examples include building management and/or security systems, though the cameras 12/16 may also or instead be used, for example, to monitor activities in an industrial plant such as on a manufacturing line.

The network 20 may take any suitable form, including a local area network, a building management system network, etc., and is shown as a wired network, such as an Ethernet system. In some examples, a fully wireless, or mixed wired/wireless network can be used as desired, operating, for example but without limitation, using cellular communication, ZigBee, REDLINK™, Bluetooth, WiFi, IrDA, dedicated short range communication (DSRC), EnOcean, and/or any other suitable common or proprietary wireless protocol, as desired. Workstations 22 on-site allow monitoring locally at the network, while console clients 30 may be local or remote. An enterprise server 24 may be present, and/or a database server 26 connected to and adapted to manage operations of memory for a database. A set of video servers 28 are present, and these may be managed internally (as by having one of the video servers operate as a load management server for the set of video servers), or by the enterprise server 24, or a dedicated server (not shown), or any other suitable computer.

In operation, the streaming cameras 16 and/or camera streamer 14 deliver data to the network 20 which is then processed by the video servers 28. The video servers 28 perform various tasks, and the tasks performed will consume video server CPU resources, video server memory, video server disk queue capacity, and/or video server network capacity. Each camera 12/16 may require different quantities of each resource at the video servers 28.

Some illustrative tasks at the video servers may include, for example and without limitation, ascertaining recorded video quality metrics. In some cases, each of the plurality of recorded video streams may include associated meta data, and processing the plurality of recorded video streams may include processing at least some of the associated meta data. Processing the plurality of video streams to ascertain one or more recorded video quality metrics may include confirming whether each corresponding recorded video stream is available, not corrupt, has been retained for a corresponding expected period of time, and/or has a desired frame rate and/or resolution.

The video servers may also process the video streams and automatically identify certain events in the video streams. For example, identifiable events may include a person or object crossing a boundary (e.g. a fence), a person trespassing, a person or object tailgating through a security check point, a person or object traveling in a wrong direction, crowd detection, vehicle counting, speeding detection, missing object detection, traffic signal jump detection, License plate recognition, loitering detection, face recognition, motion detection, camera blind detection, camera blur detection, camera field of view change detection, object classification, etc. The video servers may also perform tasks related to preparing data for storage, including compression of the data and associated tagging of compressed data to aid in later decompression as needed. Video servers can also be used to check for basic data quality using, for example, cyclic redundancy checks and/or other methods to confirm data is not corrupted.

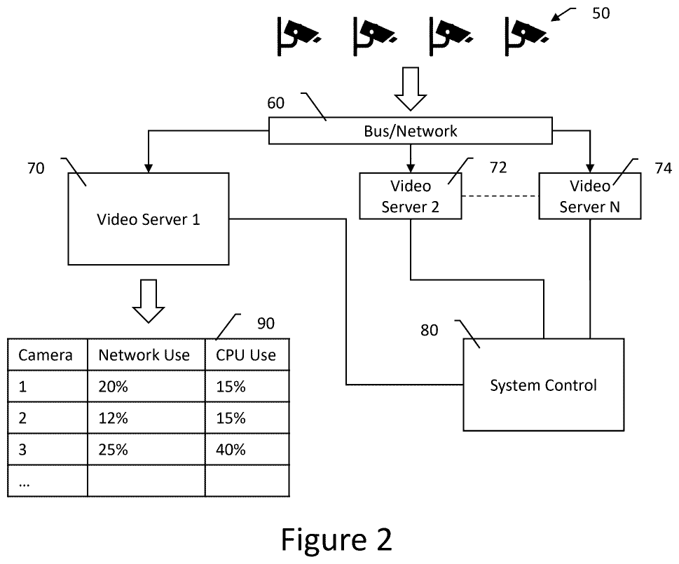

FIG. 2 schematically illustrates load management, further informing an understanding of the overall system as shown in FIG. 1. A plurality of cameras 50 each send video data to the network 60. These data feeds are obtained by video servers 70, 72, 74, which are managed by a video server system controller 80. Though shown as directly connected to the video server system controller 80, the video servers 70, 72, 74 may be connected to controller 80 over bus/network 60. The controller 80 may be part of another server (such an enterprise server or dedicated server, or even a database server as shown in FIG. 1), or may be integrated into one of the video servers 70, 72, 74. The controller 80 may instead be a stand-alone unit, configured for managing the video servers 70, 72, 74 and taking the form of a microcontroller or microprocessor and associated memory storing therein useful data as well as machine-readable and operable instructions for performing the methods disclosed herein. There may be more than three video servers 70, 72, 74, or even as few as two video servers, if desired.

In the example, video server 70 tracks a number of metrics of camera utilization (camera analytics, as used herein), as shown at 90, for each camera. In the illustration, three cameras, numbered 1, 2, 3 for purposes of illustration, are allocated to the video server 70. Network Use of each of these cameras, as well as CPU use, are shown in percentages, reflecting a percentage use of the available total network capacity and CPU capacity of video server 70. Analytics can be stored in other forms, if desired. The values shown at 90 indicate the total utilization in each of one or more, and preferably two or more categories of utilization. Additional categories may be used, such as but not limited to video server memory and/or video server disk queue. These camera analytics are reported to the system controller 80, for use as further described below. The sum of camera analytics on a particular video server may be part of the server analytics referred to below, though additional data may also or instead be included.

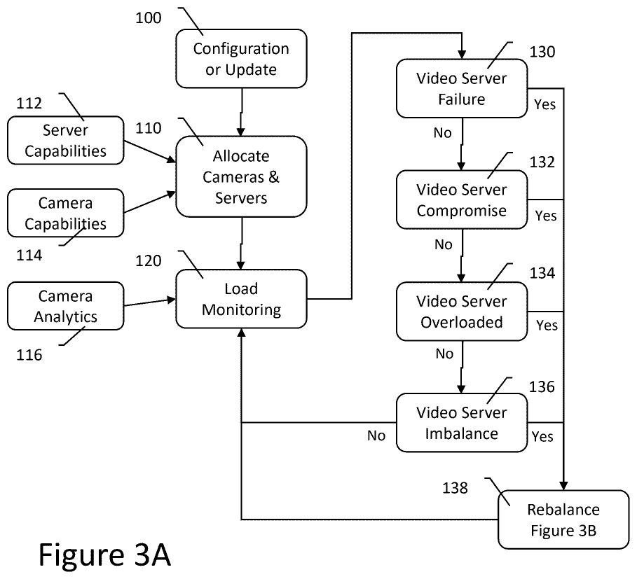

FIGS. 3A-3B are block flow diagrams for a load management process. Starting in FIG. 3A, at 100, the video management system either undergoes initial configuration, or reconfiguration after an update. At block 100, an “update” may include the addition, removal or replacement of a component, such as a camera or video server, or an aspect of the network (swapping out a switch for example). The cameras and video servers are then allocated, as shown at 110. This may include identifying server capabilities as indicated at 112 and camera capabilities 114, as well as such information as historical data for server capability and/or camera actual utilization, if available, and/or data related to how the cameras are to be used. For example, models of likely camera demand on the video servers can be generated using camera settings and information about the use to which the camera is being put, whether in a monitoring high traffic and/or low traffic areas, or if used for a critical function.

The allocation process at 110 may use any or all of this input data to determine an allocation of cameras to video servers. Block 110 may use a procedure as described below in relation to the rebalancing block 150 in FIG. 3B for the analysis of an initial allocation or re-allocation after a change. Block 110 then outputs a first configuration of the cameras and video servers.

The first configuration is then communicated to the video servers and/or network (which may include switching devices for directing data), and/or the cameras. When operating, the system uses the first configuration so that data from each camera processed at the designated video server for that camera. Load monitoring is performed, as indicated at 120. Load monitoring indicates that the system controller monitors the camera analytics generated by each of the video servers for each camera, including, for example and without limitation, one or more of CPU utilization or load, video server memory, video server disk queue, and network usage, or any other desired metric or parameter reflecting the demands placed on the video servers by the cameras. Load monitoring may also include obtaining any server analytics that are of interest, including metrics tracked by the server regarding its own performance, internal errors, memory loads, CPU use, etc.

Each video server may monitor the camera analytics for cameras assigned thereto, and may also maintain awareness of its own capabilities. Doing so may allow each video server, in the context of the operating system, to determine scenarios of overload, for example. That is, there may be scenarios where the video server software is not the only software running on the server. If so, the video server can be configured to track both the impact of camera data processing, but the general availability of resources the video server has at its disposal. The overall system manager or controller may identify imbalance and/or overload by receiving both camera analytics and server analytics for comparative purposes.

In an illustrative example, modelling or prediction of camera demand on the video server may be characterized using predicted static resource requirements. Such models can then be heuristically adjusted over time. For example, an initial model of given camera's demands on the server may be updated over time to adjust different parameters of camera demand to better align with the actual operation of the camera. The initial model can be used to set initial allocations. A runtime server (such as the system control 80 in FIG. 2) will then verify resource consumed by each camera over time. Illustrative parameters to monitor may include average and/or peak units of CPU utilization, number of threads, RAM utilization, contribution to disk write queue or latency. Such tracking can occur without necessarily needing to understand why such demands are exerted.

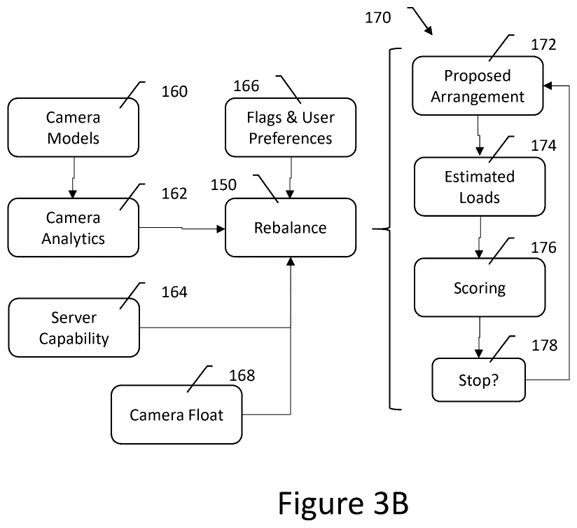

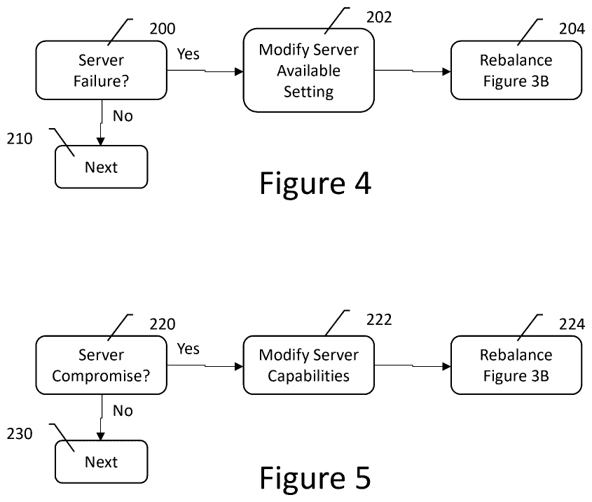

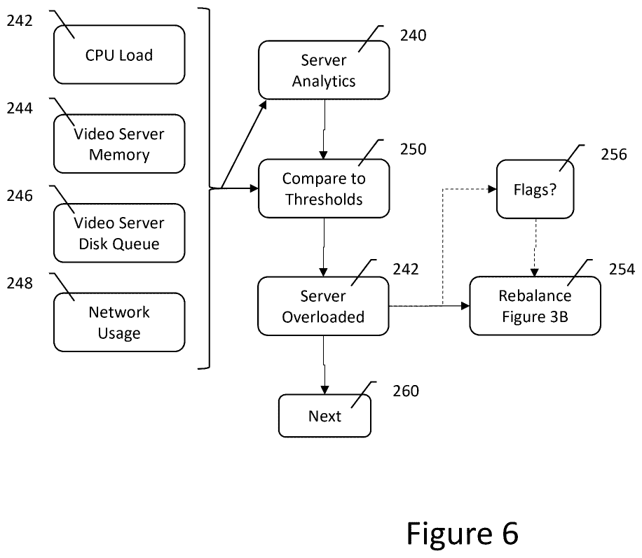

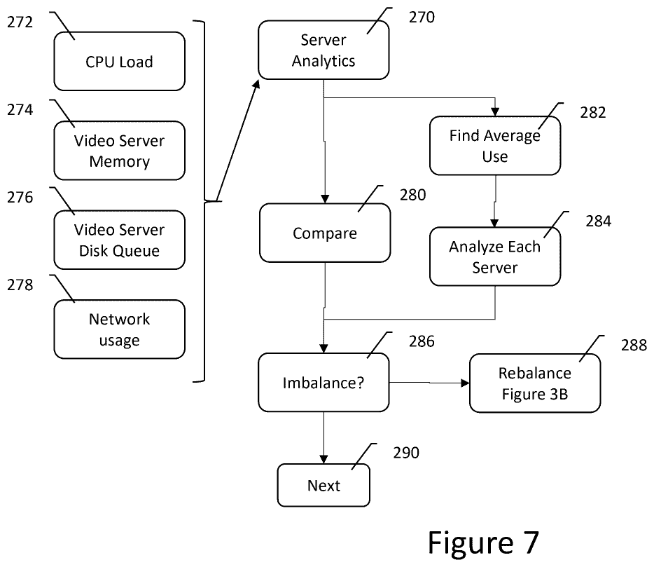

As loads are monitored at block 120, the system also checks for various events that can take place. This checking for events may occur at intervals if desired, though some of the events may generate interrupts that can be communicated to the controller, rather than occurring on a time-basis. For example, video server failure 130 is one of the possible events, and is further discussed below in relation to FIG. 4. Video server compromise 132 is another possible event, and is further discussed below in relation to FIG. 5. A video server being in an overloaded state 134 is another possible event, and is further discussed below in relation to FIG. 6. Finally, the video server system being in a state of imbalance 136 can be another event, and is further discussed below in relation to FIG. 7. It may be noted that by the time block 136 has been reached, the determination of whether the video server is overloaded has already been performed and resulted in a negative outcome. That is, the video server imbalance at 136 is determined after finding that the video serve is not overloaded.

If any of these events 130, 132, 134, 136, occur, the system executes a rebalancing procedure, as indicated at 138, which is further discussed in FIG. 3B. If none of the events occur, the method returns to load monitoring 120. If load rebalancing is performed at block 138, the system also returns to block 120, but would do so with a new configuration after execution of the method in FIG. 3B.

FIG. 3B illustrates a method of rebalancing of the allocation of cameras to video servers, with the aim of allocating load across the video servers in an even or balanced manner. The rebalancing 150 obtains various inputs. Available camera models 160, which can be augmented or replaced with actual camera analytics 162, are obtained. The capability of each server is also obtained as indicated at 164; such capabilities may be derived from server specifications, as modified by actual server performance and/or any changes to server capabilities as may occur if a server has been compromised as indicated in FIG. 5, below.

User preferences 166 and/or flags may also be obtained. For example, a user may indicate that one or more cameras are to be allocated to a particular server for whatever reason the user may have (for example, a camera deemed of higher importance to the user may be allocated to a server deemed most reliable or desirable by the user, such as the newest server or one having extra security measures built therein). Flags may be applied, either by the user or by other components in the system to indicate any rules or other issues that may be considered for rebalancing. For example, a flag may be applied in response to a determination that two cameras have correlated high activity periods, which would indicate that those two cameras may create temporary high load periods if both allocated to one video server. Negative correlation of camera feeds can be used as well, if, for example, peak activity in first and second cameras would tend to be offset in time, those two cameras may be beneficially allocated to one server. Other flags can be used, as desired.

Camera float information may be obtained, as indicated at 168. Whether a camera can be floated from one server to another may be determined, for example, by the ongoing activity of a given camera. A system-critical camera may not be able to go offline to allow float from one server to another, for example, and so the system, when performing rebalancing, may limit the available changes for such rebalancing to those that leave a specified camera or cameras on the same video server they were previously allocated to. For example, a vault door camera used for security purposes at a bank may not be floated when the vault is open; that camera may only be floated when the vault is itself closed. This is just an example.

Rebalancing 150 may include re-allocating the cameras to video servers. In some examples, the previous allocation or configuration of cameras to video servers is stored prior to any rebalancing analysis, and that configuration is then eliminated from consideration during the rebalancing procedure. Those cameras that cannot currently be floated, or “non-floatable” cameras, will be treated as having a fixed arrangement or allocation relative to their respective video servers, so that only the other cameras can be assessed. In some examples, the rebalancing analysis may include determining whether the arrangement of non-floatable cameras is creating the imbalance and, if so, generating a system alert calling for operator or human intervention.

In other examples, it may be noted that some cameras are not currently floatable, and the rebalancing analysis may identify a reallocation that would call for non-floatable cameras to float, where the reallocation is stored until a time at which the non-floatable cameras become eligible for floating. For example, the “non-floatable’ status of a camera may be temporary; using the bank security camera as an example, a vault security camera may be non-floatable when the vault is open. However, once the vault is closed, the vault camera can be floated and the reallocation can be implemented.

In a still further example, a reallocation may be partly implemented, by reallocating those cameras that can be floated at one time, and waiting until the remaining cameras can also be floated to fully implement the reallocation. Such an extended or piecemeal approach to the reallocation may be useful where the overall system has cameras that cannot be floated at different times. Again using a bank example, a vault camera may only be floatable when the vault is closed, and a front door camera may be only floatable when the front door is being observed by a security guard. These two time periods may not overlap, and so reallocation may need to be implemented in piecemeal fashion.

Rebalancing 150 can take many forms, and may start with determining a new allocation or reallocation of the cameras to the video servers. An example approach to rebalancing is shown at 170. Here, a series of proposed arrangements of cameras is generated, as indicated at 172. The proposed arrangements are analyzed to determine estimated total loads on each server, as indicated at 174. Each proposed arrangement is then given a score. This analysis is performed iteratively until a stop conditions arises, as indicated at 178.

The scoring may be determined, for example and without limitation, using statistics and/or a cost minimizing analysis in which each of one or more categories of video server utilization is analyzed. For example a mean utilization across all servers can be calculated for each of one or more categories of utilization, and then a standard deviation from the mean in each category for the proposed arrangement is calculated. The standard deviations may be weighted, if desired, to emphasize or de-emphasize selected characteristics of operation, as desired. Thus, for each i^{th} proposed solution, a score may be:

$${Score}_{i} = {\sum }_{∀ j} {w}_{j} {σ}_{j}$$

Where the system has j analytics considered, with the sigma symbol (σ) representing the standard deviation for the particular analytic, and w the weight for the particular analytic. Variance may be used instead of standard deviation, if desired. The use of weights is optional.

The above approach, using a score as a sum of analytics, is just one example. Other approaches can be used. For example, each of the camera/server analytics can be separately analyzed to rule out any proposed analytics having outliers in any one category.

For example, the control server may model each camera's resource usage, with a predicted set of resource requirements foreach camera, measured in units of different resource classes. Each video sever may estimate how loaded it is by measurement in those units. Summing the allocation of cameras to a given video server then, each video server would have predicted first demands, and then, later, using real runtime data refined later predicted demands. The video server may, in some examples be able to report to the video server system controller how close to estimated limits of resource utilization it finds itself on average over unified time laps.

Additional metrics can be defined based on how the video server itself performs. For example, resource class independent tests may estimate or measure how well a video server executes list of unified critical activities measured in, for example, time and/or/CPU cycles.

Some examples may include more than one mode of load balancing. In one mode, for example, the set of video servers must service all cameras they know about in the system. This may force some of the video servers to operate under stress. “Stress” may indicate, for example, a percentage of resource allocation across all metrics, and/or may be a percentage of resource defined for each class of resource consumption, where one or more thresholds are applicable to the total set of metrics and/or each individual class of resource consumption. In a second mode, additional cameras can be added to a video server only if the video server itself indicates it is stress free. Here, video server stress level is published by each video server, and so the system control as well as each individual video server will be aware of each video server's stress level relative to all other video servers in the assembled system. Servers with relatively low stress level will be the first to add free cameras or cameras other servers register to be floated out. Servers with elevated stress level relative to other servers will be the first to request floating a camera out. It may be expected that re-balancing typically would happen in the initial period of operation of the system, as each video server and the overall system learns about itself and the cameras. As time passes, rebalancing is more likely to occur in response to various kinds of server(s) failures and/or when changes to the system occur, such as when cameras are swapped, added and/or removed.

Other examples may use, for example, a neural network, machine learning, or artificial intelligence, to identify a balanced solution. Tiers of rules can apply. For example, only proposed arrangements that do not violate the “overloaded server” rules applied below in FIG. 6 will be considered. Furthermore, user preferences and flags may be used to rule out certain proposed arrangements before scoring.

When the new allocation of cameras to video servers is determined, the new allocation is then implemented by the control server issuing commands to the video servers, cameras, and/or network to redirect the output of one or more cameras to one or more different video servers than was previously in place.

FIG. 4 is a block flow diagram for identifying and responding to video server failure. Server failure is posed as a query at 200. Server failure may be determined in several ways, and any of the resources connected to the network or video server may identify failure of a video server. In some examples, the system controller is in ongoing communication with each video server (continuous, round robin, periodic, etc.) and the video server may be queried as to status; if the video server reports failure that would be one approach. In some examples, each camera sends data in packets and receives acknowledgements from the video server in a more or less continuous manner, so failure by the video server to issue an expected acknowledgement may trigger the camera to communicate a server failure message directed to the system controller. A database server may likewise report video server failure if a feed of data to the database is interrupted. The database server may also intervene to identify video server failure if the database server identifies corrupt data. Some such “failures” may arise from network issues in the transmission of data, however, this is not expected to be frequent. In any event, any failure of a video server, however identified, would likely also result in a maintenance flag being raised so that troubleshooting can be performed. In the meantime, the system as disclosed herein will adjust to the identified failure as further discussed below.

If the query at 200 yields a yes, then the server availability setting is modified. The failing or failed server is flagged as unavailable for further use. This then triggers rebalancing, as indicated at 204, and the process of FIG. 3B is called. If no server failure is identified, the process moves to the next check, as indicated at 210. Assuming the ordering of FIG. 3A is used (any other order of steps can be used, as desired), the system proceeds to FIG. 5.

FIG. 5 is a block flow diagram for identifying and responding to video server compromise. Here, compromise means a reduction in the operability of a video server, reducing capacity in one or more ways. For example, bad memory sectors in RAM may affect and reduce the server memory capacity. Generally speaking, server compromise 220 would likely be identified by the affected video server itself, though any of the resources connected to the network or video server may identify server compromise.

Server compromise affects the capabilities of the video server, and so block 222 is called, and the stored server capabilities used when determining an allocation of cameras and video servers is changed and/or updated. The process then goes to rebalancing 224, using a process as discussed in FIG. 3B. If no server compromise is identified, the process moves to the next check, as indicated at 230. Assuming the ordering of FIG. 3A is used (any other order of steps can be used, as desired), the system proceeds to FIG. 6.

FIG. 6 is a block flow diagram for identifying and responding to video server overload. Here, server analytics are obtained 240. The server analytics may include various categories, as shown to the left, such as CPU load 240, video server memory 242, video server disk queue 286, and/or network usage 288. Server analytics may be a sum of the camera analytics allocated to each server, if desired. Other metrics of server load may be analyzed as well, including secondary factors, such as internal queue size for video server functions like video analytics (whereby a long queue may be reflective of the inability to process video analytics, like motion detection, in real time), database access failures where the network communications to the Database Server may otherwise be fine, one or more cameras being uncontactable over the network from the video server (where floating the camera to another server may provide an alternate and healthy means of network access), time of day (if peak loads are known to occur at certain times, for example), server temperature, error rates, any of which may indicate a server that is operating in an overloaded state. Examples may consider various combinations as well, for example, RAM may be analyzed both in terms of relative utilization, as well as absolute utilization in a given video server. Some metrics may relate to video server tasks by monitoring for time to completion or CPU cycles to completion. With RAM, for example, the time or CPU cycles required to allocate a new block of memory can be monitored and reported. Number of threads on a given video server can be considered as the parameter can be proportional to CPU cycles wasted on context switching. Internal queues may be important in some video servers and systems, including the amount of pre-record. Other class-independent tests measure video server performance of tasks including time to reach the database, time to reach video server, time to complete start or stop recording operations, time to access a streamer, or other operations performed over the network.

Metrics related to camera utilization, as well as any other metrics, are compared to one or more thresholds at 250, which may be tailored to a particular video server based on the configuration or characteristics thereof. If any threshold is exceeded, the server may be deemed overloaded, as indicated at 252, and rebalancing is executed using a process as discussed in FIG. 3B. If no server compromise is identified, the process moves to the next check, as indicated at 260. Assuming the ordering of FIG. 3A is used (any other order of steps can be used, as desired), the system proceeds to FIG. 7.

FIG. 7 is a block flow diagram for identifying and responding to video server imbalance. Server analytics are gathered, as indicated at 270, and may include CPU load 272, video server memory 274, video server disk queue 276, and/or network usage. The purpose in FIG. 7 is to analyze the video servers, and so the data obtained at 270 is does not necessarily have to be focused on the particular camera loads on the server, but instead, on the cumulative load experienced by the video server. If desired, analytics at 270 may include peak usage on the server itself.

An imbalance can be identified by comparing, as shown at 280, utilization of each video server to the utilization of other servers. This may include, for example and without limitation, comparing at least one of CPU utilization, video server memory, video server disk queue, or network utilization of a first video server to that of at least a second video server. For example, each may be compared to one another, using each category of server analytics if desired. Whether an imbalance exists can then be determined at 286 using the one or more comparisons.

In another example, deviation from average utilization can be assessed, rather than direct comparison of server utilization. Here, average load across all the video servers is then analyzed, as indicated at 282. This may include consideration of multiple video server analytics. Each server can then be scored as indicated at 284 in relation to the identified average use from 282. Each of the analyzed server analytics may be separately analyzed, so that an imbalance can be identified on a granular level.

In another example, a composite load score can be determined for each of the video servers. Here, for each analytic, an estimated utilization as a percentage of capacity for each video server is determined. The estimated utilization for each analytic can be weighted and then summed for each video server. Weighting may, for example, consider the amount of wear and tear that a given analytic represents. For example, memory read-write may be considered to cause more wear and tear than elevated CPU utilization, and so video server memory utilization 274 may be over-weighted when determining a composite load score. Weighting can also be used in other steps, as desired, throughout FIG. 7. Weighting is optional.

If an imbalance is identified at block 286, the system is rebalanced by proceeding to FIG. 3B, as indicated at 288. Otherwise, the system moves to the next analysis or step, as indicated at 290. Using the ordering of steps shown in FIG. 3A, this would return to load monitoring, though any other order of steps can be used as desired.

Balancing of video server loads may include analysis of both worst-case and average loading. For example, actual server experience of camera utilization of resources may not represent the worst-case loading. Each camera may have different and varying demands on the video server. To assess worst case loading, each camera's load including mean or average demand, as well as peak usage can be characterized. By summing the camera utilization peaks, the possibility of video server overload may be identified. Likewise, the identification of overloaded servers or imbalanced servers may use a similar analysis. That is, even if the worst case has not arisen, the potential for a worst-case scenario—that is, all cameras on a given video server simultaneously demanding peak resource utilization—can be analyzed and mitigated. The analysis of worst case scenario can be used to ensure headroom in the resource capacity of video servers, which in turn can help limit requests for video server floating.

For example, each video server may internally track resource utilization by each of the cameras associated with the server for both average use and peak use. Such values can be obtained by or communicated to the overall system controller, which may use worst-case analysis (by any suitable method for so doing) to identify allocation of cameras to video servers that accommodates peak utilization without frequent camera float. The identification of possible video server overload can thus be addressed as well using these metrics.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A method of load management in a video management system, the system including a plurality of cameras and a plurality of video servers, the method comprising:
operating the cameras and the video servers with a first allocation of the plurality of cameras to respective video servers;
monitoring utilization metrics for each camera at the respective video server for each camera;
determining that a first video server is imbalanced relative to at least one other video server;
in response to determining the first video server is imbalanced:
determining a reallocation of the plurality of cameras to the plurality of video servers, resulting in a second allocation; and
implementing the second allocation.

2. The method of claim 1, wherein the step of determining a reallocation of the plurality of cameras to the plurality of video servers comprises:
analyzing a state of each of the plurality of cameras to determine whether any of the plurality of cameras cannot be currently re-allocated and, if so, designating such cameras as not floatable; and
determining the reallocation without allowing reallocation of any not floatable cameras.

3. The method of claim 1, wherein the step of determining a reallocation of the plurality of cameras to the plurality of video servers comprises:
analyzing a state of each of the plurality of cameras to determine whether any of the plurality of cameras cannot be currently re-allocated and, if so, designating such cameras as not floatable and designating the remaining cameras as floatable cameras; and
determining the reallocation by allowing reallocation of all of the plurality of cameras;
wherein the step of implementing the second allocation comprises reallocating at least one floatable camera at a first time, and reallocating at least one non-floatable camera at a second, later time.

4. The method of claim 1, wherein the step of determining that the first video server is imbalanced comprises comparing, at a video server controller, at least one of CPU utilization, video server memory, video server disk queue, or network utilization of the first video server to that of a second video server.

5. The method of claim 1, wherein the step of determining that the first video server is imbalanced comprises comparing, at a video server controller, at least one of CPU utilization, video server memory, video server disk queue, or network utilization of the first video server to that of an average of the plurality of video servers.

6. The method of claim 1, further comprising determining that a second video server has failed and can no longer process data from at least a second camera allocated thereto under the first allocation, and in response, reallocating the second camera to another video server.

7. The method of claim 1, further comprising determining that a second video server has failed and can no longer process data from at least a second camera allocated thereto under the first allocation, and in response, determining a reallocation of the plurality of cameras to the plurality of video servers, less the second video server.

8. The method of claim 1, further comprising determining that a second video server has been compromised and has a reduced operational capacity in at least one of CPU capability, video server memory, video server disk queue, or network capacity, and in response, determining a reallocation of the plurality of cameras to the plurality of video servers, by updating an estimated capacity of the second video server.

9. The method of claim 1, further comprising determining that a second video server is overloaded in at least one of CPU utilization, video server memory, video server disk queue, or network utilization, and in response, determining a reallocation of the plurality of cameras to the plurality of video servers, less the second video server.

10. The method of claim 1, further comprising determining that the first video server is not overloaded by comparison of performance or utilization metrics of the first video server to one or more thresholds for overloading prior to determining that the first video server is imbalanced.

11. The method of claim 1, wherein the video system controller is configured to determine the reallocation of the plurality of cameras to the plurality of video servers using estimates of peak resource utilization demands of the cameras on the video servers without identifying overload of any of the plurality of video servers.

12. The method of claim 1, wherein the video system controller is configured to determine the first video server is imbalanced by analysis of time or CPU cycles required for the first video server to accomplish one or more tasks.

13. A method of load management in a video management system, the system including a plurality of cameras and a plurality of video servers, the method comprising:
operating the cameras and the video servers with a first allocation of one or more cameras to respective video servers;
monitoring utilization metrics for each camera at the respective video server for each camera;
determining that a first video server is imbalanced relative to at least one other video server; and,
in response, reallocating a first camera allocated to the first video server in the first allocation to a different video server.

14. A video management system comprising:
a plurality of cameras;
a plurality of video servers;
a network connecting the plurality of cameras to the plurality of video servers, the network implementing a first allocation of the plurality of cameras to respective video servers;
each respective video server in the system configured to monitor utilization metrics for each camera at the respective video server for each camera; and
a video system controller configured to:
determine that a first video server is imbalanced relative to at least one other video server; and
in response to the first video server being imbalanced:
determine a reallocation of the plurality of cameras to the plurality of video servers, resulting in a second allocation; and
implement the second allocation.

15. The video management system of claim 14, wherein the video system controller is configured to determine a reallocation of the plurality of cameras to the plurality of video servers by:
analyzing a state of each of the plurality of cameras to determine whether any of the plurality of cameras cannot be currently re-allocated and, if so, designating such cameras as not floatable; and
determining the reallocation without allowing reallocation of any not floatable cameras.

16. The video management system of claim 14, wherein the video system controller is configured to determine a reallocation of the plurality of cameras to the plurality of video servers by:
analyzing a state of each of the plurality of cameras to determine whether any of the plurality of cameras cannot be currently re-allocated and, if so, designating such cameras as not floatable and designating the remaining cameras as floatable cameras; and
determining the reallocation by allowing reallocation of all of the plurality of cameras;
further wherein video system controller is configured to implement the second allocation by:
reallocating at least one floatable camera at a first time;
reallocating at least one non-floatable camera at a second, later time after determining that the non-floatable camera has become floatable due to expiration or ending of a process or condition involving the non-floatable camera.

17. The video management system of claim 14, wherein the video system controller is configured to determine that the first video server is imbalanced by comparing at least one of CPU utilization, video server memory, video server disk queue, or network utilization of the first video server to that of a second video server.

18. The video management system of claim 14, wherein the video system controller is configured to determine that the first video server is imbalanced by comparing at least one of CPU utilization, video server memory, video server disk queue, or network utilization of the first video server to that of an average of the plurality of video servers.

19. The video management system of claim 14, wherein the plurality of video servers are each configured to identify at least one of failure, overload, or compromise, and to communicate such failure, overload, or compromise to the video system controller, and the video system controller is configured, in response thereto, to determine a new allocation of the plurality of cameras to accommodate the communicated failure, overload, or compromise.

20. The video management system of claim 14, wherein the video system controller is configured to determine that the first video server is imbalanced without the first video server determining a state of overload.
